(19) United States
(12) Patent Application Publication
(10) Pub. No.: US 2026/0312779 A1
(43) Pub. Date: Oct. 8, 2026

(54) DEVICES AND METHODS FOR INITIAL ACCESS

(71) Applicant: LENOVO (BEIJING) LIMITED, Beijing (CN)

(72) Inventors: Yuantao Zhang, Beijing (CN); Ruixiang Ma, Beijing (CN); Zhi Yan, Beijing (CN)

(21) Appl. No.: 19/479,260

(22) PCT Filed: Apr. 28, 2023
(86) PCT No.: PCT/CN2023/091711

§ 371 Date: Oct. 27, 2025

(51) Int. Cl. H04L 5/14; H04L 5/00; H04W 74/00; H04W 74/0833

(52) U.S. Cl. CPC H04L 5/14; H04L 5/0094; H04W 74/004; H04W 74/0833

(57) ABSTRACT

Embodiments of the present disclosure relate to devices and methods for initial access in a communication network. In an aspect, a terminal device receives a configuration related to a first initial uplink (UL) bandwidth part (BWP) and a second initial UL BWP from a network device. The terminal device determines the second initial UL BWP based on the configuration. The second initial UL BWP comprises a UL subband. In this way, the UL subband can be used for SBFD aware UEs during the initial access.

### FIELD

Embodiments of the present disclosure generally relate to the field of communication, and in particular to devices, methods, and a non-transitory computer readable medium for initial access in a communication network.

### BACKGROUND

In wireless communication system, the term “duplex” means bidirectional communication between two devices, where the transmissions over the link in each direction may take place at the same time (i.e., full duplex) or mutual exclusive time (i.e., half duplex). In legacy full duplex transceivers, different carrier frequencies are employed for each link direction. This is known as full duplex frequency division duplex (FD-FDD). Conversely, in a half-duplex (HD) transceiver, the link directions are separated by time domain resources.

Advanced full duplex modes enable simultaneous transmission and reception by the same device on the same carrier, thus having the potential to double the link throughput. The transmission latency is also reduced thanks to bidirectional transmission simultaneously. Certain communication procedures can be applied to a full duplex network.

### SUMMARY

In general, example embodiments of the present disclosure provide devices, methods, and a non-transitory computer readable medium for initial access in a communication network, especially, in a full duplex network.

In a first aspect, there is provided a terminal device. The terminal device comprises a processor and a transceiver coupled to the processor. The processor is configured to: receive, via the transceiver from a network device, a configuration related to a first initial uplink (UL) bandwidth part (BWP) and a second initial UL BWP; and determine the second initial UL BWP based on the configuration, wherein the second initial UL BWP comprises a UL subband.

In a second aspect, there is provided a network device. The network device comprises a processor and a transceiver coupled to the processor. The processor is configured to: transmit, via the transceiver to a terminal device, a configuration related to a first initial UL BWP and a second initial UL BWP; and determine the second initial UL BWP based on the configuration, wherein the second initial UL BWP comprises a UL subband.

In a third aspect, there is provided a method performed by a terminal device. The method comprises: receiving, from a network device, a configuration related to a first initial UL BWP and a second initial UL BWP; and determining the second initial UL BWP based on the configuration, wherein the second initial UL BWP comprises a UL subband.

In a fourth aspect, there is provided a method performed by a network device. The method comprises: transmitting, to a terminal device, a configuration related to a first initial UL BWP and a second initial UL BWP; and determining the second initial UL BWP based on the configuration, wherein the second initial UL BWP comprises a UL subband.

In a fifth aspect, there is provided a non-transitory computer readable medium. The non-transitory computer readable medium having program instructions stored thereon. The program instructions, when executed by an apparatus, causing the apparatus at least to perform the method according to the third aspect or the fourth aspect above.

In a sixth aspect, there is provided a computer program product. The computer program product comprises instructions. The instructions, when executed by a processor of an apparatus, causing the apparatus at least to perform the method according to the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates an example network environment in which some embodiments of the present disclosure can be implemented;

FIG. 1B illustrates example duplex modes related to some embodiments of the present disclosure;

FIG. 1C illustrates an example diagram of subband full duplex (SBFD) related to some embodiments of the present disclosure;

FIG. 1D illustrates an example diagram of a random access procedure related to some embodiments of the present disclosure;

FIG. 1E illustrates an example diagram of a configured initial DL BWP and initial UL BWP related to some embodiments of the present disclosure;

FIG. 2 illustrates an example signaling chart of an example process according to some embodiments of the present disclosure;

FIG. 3A illustrates an example diagram of a frequency domain allocation of an initial DL BWP, an initial UL BWP and a UL subband, according to some embodiments of the present disclosure;

FIG. 3B illustrates an example diagram of a separate initial UL BWP configured for SBFD aware UEs, according to some embodiments of the present disclosure;

FIG. 4 illustrates an example diagram of a determination of a separate initial UL BWP, according to some embodiments of the present disclosure;

FIG. 5 illustrates an example diagram of random access channel (RACH) occasions (ROs) shared by SBFD aware UEs and reduced capability (RedCap) UEs, according to some embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure; and

FIG. 8 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” or “downlink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

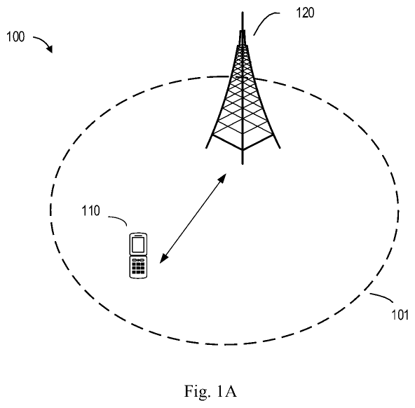

FIG. 1A illustrates an example network environment 100 in which example embodiments of the present disclosure may be implemented. The environment 100, which may be a part of a communication network, comprises terminal devices and network devices.

As illustrated in FIG. 1A, the communication network 100 may comprise a terminal device 110 (hereinafter may also be referred to as user equipment 110 or a UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In wireless communication system, the term “duplex” means bidirectional communication between two devices, where the transmissions over the link in each direction may take place at the same time (i.e., full duplex) or mutual exclusive time (i.e., half duplex).

In legacy full duplex transceivers, different carrier frequencies are employed for each link direction. This is known as FD-FDD. Conversely, in a HD transceiver, the link directions are separated by time domain resources. When the same carrier frequency is used for each link direction, the HD transceiver is referred as a time division duplex (TDD) system, while if different carrier frequencies are used, the system is known as half duplex FDD (HD-FDD). FIG. 1B illustrates example duplex modes related to some embodiments of the present disclosure. As shown in FIG. 1B, there are FD-FDD mode, TDD mode and HD-FDD mode.

Advanced full duplex modes enable simultaneous transmission and reception by the same device on the same carrier, thus having potential to double the link throughput. The transmission latency is also reduced due to bidirectional transmission simultaneously. However, simultaneous DL and UL in a same carrier will incur self-interference. In the BS side, this means DL transmission contaminating UL reception, while in the UE side, the UL transmission might contaminate DL reception.

In practice, it is more feasible to realize full duplex in BS side than in UE side because more space is available in the BS side and Tx/Rx antenna branches can be separated for self-interference cancellation. Besides, more advanced receiver can be adopted in the BS side, which is fundamental for self-interference cancellation.

Therefore, one scenario is to deploy full duplex in BS side only, while half duplex is still used in the UE side. This means in a set of time slots, the BS may transmit data signal to some UEs, and receive data signal from others in a same carrier. In addition, non-overlapped frequency resources could be allocated for DL transmission (to some UEs) and UL reception (from other UEs) to mitigate self-interference.

One practical usage scenario is to use full duplex to enhance the UL performance in TDD system. UL subband(s) could be configured in some of the DL slots so that more resources are available for UL transmission. With this, for DL symbols configured with UL subband, the UL transmissions could be scheduled in the subband(s) while DL transmissions could be scheduled in the PHY resources out of the subband(s). Such full duplex framework is known as SBFD. A UE that is aware of the SBFD used by the BS is called an SBFD aware UE, while a UE that is not aware of the SBFD used by the BS is called a non-SBFD aware UE.

FIG. 1C illustrates an example e diagram of SBFD related to some embodiments of the present disclosure. As shown in FIG. 1C, a UL subband is configured on the symbols in two DL slots. For SBFD aware UEs supporting BS side full duplex, physical uplink shared channel (PUSCH) could be scheduled in this subband in such DL slots. In the UL slots, the UL transmission is scheduled in the active UL BWPs. Although FIG. 1C shows UL subband configured on the DL symbols, in practice, the UL subband can also be configured on flexible symbols of TDD system.
the time and frequency resources of UL subband can be configured in the system information block (SIB), which is broadcast to all the SBFD aware UEs.

For a UE that in powering on, or for a radio resource control (RRC) idle/inactive UE switching to RRC connected, the UE will first monitor the SIB to receive the necessary configuration e.g., the configuration of initial DL BWP and initial UL BWP, and then starts a random access procedure.

FIG. 1D illustrates an example diagram of a random access procedure related to some embodiments of the present disclosure. As shown in FIG. 1D, the UE firstly transmits a Message 1 (Msg1) preamble to the BS, and then receives a Random-Access Response (RAR) in Message 2 (Msg2), indicating reception of the preamble and providing necessary information for the transmission of Message 3 (Msg3). The Msg3 and Message 4 (Msg4) are used to solve potential collisions due to simultaneous transmissions of the same preamble from different UEs. After received Msg4, the UE will send a HARQ-ACK to the BS to indicate whether Msg4 is correctly received in UE side.

The messages in the random access procedure are transmitted/received in the initial DL BWP and initial UL BWP. For all the UEs that are performing the random access procedure during initial access, the messages are multiplexed in the same initial DL and UL BWPs.

As specified, the initial DL BWP and the initial UL BWP should be center frequency aligned. This avoids RF retuning when the UE switches from initial DL BWP (for receiving DL messages) to the initial UL BWP (for transmitting messages). FIG. 1E shows an illustration of the configured initial DL BWP and initial UL BWP, where the two BWPs are center frequency aligned. The BW of the initial UL BWP may be smaller than the initial DL BWP, given that the UL messages are typically small during initial access and thus do not need much resource for transmission. Configuring small BW UL BWP is also beneficial in terms of UE power saving.

Specifically for UL, the signals transmitted in the initial UL BWP during the random access procedure may include:
Msg1, which is transmitted in a configured RACH occasion (RO) in the initial UL BWP;
Msg3 transmission and retransmission (if retransmission is needed); and
Msg4 HARQ-Ack feedback, which is transmitted in configured physical uplink control channel (PUCCH) resource in the initial UL BWP.

For SBFD, since the UL subband is configured in the SIB, there is a chance to use the UL subband to transmit UL messages involved in the random access procedure. This is beneficial in terms of reducing initial access latency.

However, the UL subband might not be within the initial UL BWP, which is typically configured with small BW as indicated in above. In this case, if using UL subband during initial access, the UE needs to perform RF retuning between the initial DL BWP and the UL subband when transiting from DL (/UL) to UL (/DL) if the UL subband and the initial DL BWP are not center frequency aligned (which is the typical scenario). This leads to more UE implementation complexity.

To solve this issue, the gNB might configure a large size initial UL BWP to include the UL subband. However, since the initial UL BWP is shared by all the UEs, a large size initial UL BWP might not be preferred by legacy UEs because it means more power consumption for the legacy UEs.

Given the above, embodiments of the present disclosure provide solutions for an initial access for UEs in a full duplex network, which may use a UL subband for SBFD aware UEs during the initial access. In an aspect of the solution of the present disclosure, a terminal device may receive, from a network device, a configuration related to a first initial UL BWP and a second initial UL BWP, and the terminal device may determine the second initial UL BWP based on the configuration. The second initial UL BWP comprises a UL subband. In this way, it may not impact the legacy UEs performance, and SBFD aware UEs implementation complexity may be not increased.

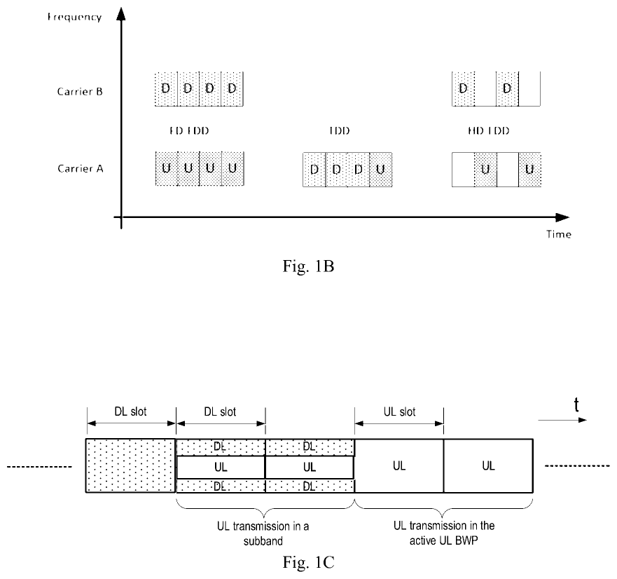

Principles and implementations of embodiments of the present disclosure will be described in detail below with reference to FIGS. 2-8.

### Example Method

FIG. 2 illustrates an example signaling chart illustrating an example process 200 according to some embodiments of the present disclosure. For the purpose of discussion, the example 200 will be described with reference to FIG. 1, and the process 200 may involve the terminal device 110 and the network device 120 as shown in FIG. 1.

As shown in FIG. 2, the network device 120 transmits 210 a configuration 212 related to a first initial UL BWP and a second initial UL BWP to the terminal device 110. The first initial UL BWP may be a legacy initial UL BWP that can be used by both the SBFD aware UEs and non-SBFD aware UEs. The second initial UL BWP may be configured or determined for the SBFD aware UEs. On the terminal device side, the terminal device 110 receives 214 the configuration related to a first initial UL BWP and a second initial UL BWP.

In the present disclosure, the first initial UL BWP can be also referred to as a legacy initial UL BWP or an initial UL BWP for legacy UEs/non-SBFD aware UEs. The second initial UL BWP can be also referred to as a separate initial UL BWP or an initial UL BWP for SBFD aware UEs. It should be noted if separate initial UL BWP is not configured for the SBFD aware UEs, the SBFD aware UEs will share a same legacy initial UL BWP with the non-SBFD aware UEs.

For instance, to use UL subband for SBFD aware UEs during initial access, it is proposed that separate initial UL BWP (e.g., the second initial UL BWP) can be configured or determined for the SBFD aware UEs, and the separate initial UL BWP may contain the UL subband. The separate initial UL BWP for SBFD aware UEs may be center frequency aligned with the configured initial DL BWP, such that RF retuning between initial DL BWP and (separate) initial UL BWP is not needed for SBFD aware UEs during initial access.

The initial DL BWP is shared by the SBFD aware UEs and non-SBFD aware Ues. The initial UL BWP for SBFD aware Ues contains the UL subband, while the initial UL BWP of legacy UEs might not contain the UL subband. The legacy Ues can be still configured with a small BW initial UL BWP, then the power consumption is not increased for the legacy UEs during initial access.

In some embodiments, the second initial UL BWP may be applicable to DL symbols or flexible symbols configured with the UL subband and may be also applicable to a UL slot. Hereafter these symbols are named as SBFD symbols. Alternatively, the first UL BWP may be applicable to a UL slot, while the second initial UL BWP may be applicable to SBFD symbols. In another case, the second initial UL BWP may be applicable to SBFD symbols, and whether the second initial UL BWP is applicable to a UL slot may be based on configuration information from the network device 120.

For example, for SBFD aware UEs, there are three options regarding the usage of the configured or determined separate initial UL BWP. In option 1, the separate initial UL BWP may be applicable for both SBFD symbols and UL symbols (in UL slots). In option 2, the separate initial UL BWP may be applicable for only SBFD symbols, while the legacy initial UL BWP is applicable for the UL symbols. In option 3, the separate initial UL BWP may be applicable for SBFD symbols, and whether it is also applicable to UL symbols is based on a configuration from the network device.

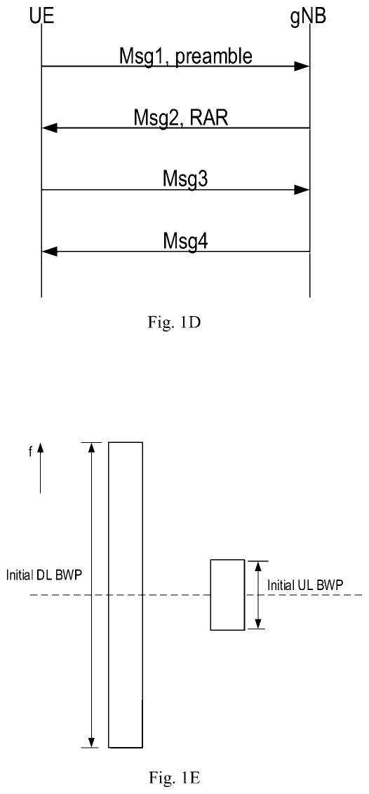

Reference is made to FIGS. 3A and 3B. FIG. 3A illustrates an example diagram of a frequency domain allocation of an initial DL BWP, an initial UL BWP and a UL subband. The UL subband is outside of the configured initial UL BWP. It is to be understood that the frequency locations and bandwidths of the initial DL BWP, initial UL BWP and UL subband are only for the purpose of illustration without suggesting any limitations. The initial DL BWP, initial UL BWP and UL subband may be configured with any suitable frequency locations and bandwidths.

To use the UL subband during the initial access, a separate initial UL BWP is configured for SBFD aware UEs, which is shown in FIG. 3B. The separate initial UL BWP for SBFD aware UEs contains the UL subband and it is used in the DL symbols with UL subband (i.e., SBFD symbols), as shown in FIG. 3B. In the UL slot, the legacy configured initial UL BWP is used for both SBFD aware UEs and non-SBFD aware UEs, which is corresponding to the above option 2.

It should be noted that, the separate initial UL BWP corresponding to the above option 1 and option 3 can be derived based on FIG. 3B and is within the scope of the present disclosure, although it is not shown.

Reference is made back to FIG. 2. Based on the configuration 212, the terminal device 110 determines 216 the second initial UL BWP (e.g., the separate initial UL BWP). The second initial UL BWP comprises a UL subband. In the network side, the network device determines 216 the second initial UL BWP.

In some embodiments, the configuration 212 may indicate a frequency location and bandwidth of the second initial UL BWP. In this case, the terminal device 110 may determine the second initial UL BWP based on the indicated frequency location and bandwidth of the second initial UL BWP. Alternatively, the configuration 212 may indicate to determine the second initial UL BWP, for example, the configuration 212 may be an indication that indicates the terminal device to determine the second initial UL BWP. In this case, the determination may be based on a frequency location of at least one of the UL subband, the first initial UL BWP and an initial DL BWP.

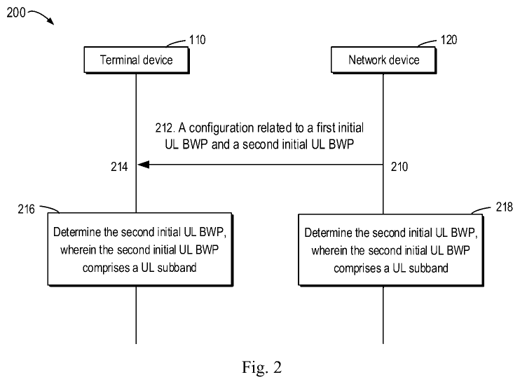

For instance, the frequency location of the separate initial UL BWP can be configured by introducing a new signaling in the SIB, or it could be implicitly determined by the frequency location of at least one of the UL subband, initial DL or UL BWP. For example, the determination could be based on a first principle that the lowest resource block (RB) of the UL subband is aligned with the lowest RB of the separate initial UL BWP, and a second principle that the center frequency of the separate initial UL BWP is aligned with that of the initial DL BWP. FIG. 4 shows an example of such determination, where it is assumed that there are K RBs between the lowest position of the UL subband and the center frequency of the initial DL (or UL) BWP. This results in a totally 2K RBs separate initial UL BWP for SBFD aware UEs, as shown in the figure.

It is to be understood that the determination manner of the separate initial UL BWP shown in FIG. 4 is only for the purpose of illustration without suggesting any limitations. Any appropriate manner can be used for determining the separate initial UL BWP based on the UL subband, the legacy initial UL BWP or the initial DL BWP. For example, if the UL subband is above in frequency than the legacy initial UL BWP, the determination could be based on a first principle that the highest RB of the UL subband is aligned with the highest RB of the separate initial UL BWP, and a second principle that the center frequency of the separate initial UL BWP is aligned with that of the initial DL BWP.

To support Msg3 transmission and Msg4 hybrid automatic repeat request (HARQ) acknowledgement (ACK)/negative acknowledgement (NACK) transmission in the separate initial UL BWP, it is proposed that early identification (e.g., an indication) of SBFD aware UEs is needed in Msg1, so that when the BS receives the a specific Msg1 from a SBFD aware UEs, it could schedule Msg3 and Msg4 HARQ-ACK/NACK transmission in the separate initial UL BWP.

Early identification of SBFD aware UEs could be through configuration of separate physical random access channel (PRACH) resources for the UEs. The separate PRACH resources could be separate ROs and/or separate preambles. To reduce standard impact, it is proposed to rely on existing configuration, i.e., FeatureCombination, as defined in NR specification TS38.331, for configuring separate PRACH resources for SBFD aware UEs. The signaling FeatureCombination has included RedCap/small data/nsag/msg3-repetition as the features that could be configured with separate PRACH resources, as shown in below. To reuse this signaling, it is proposed to introduce SBFD aware UEs as a new feature in this signaling. For example, a spare information element in the signaling is used to indicate whether separate PRACH resources should be configured for SBFD-aware UEs or for SBFD-aware UEs combined with other features, e.g., SBFD aware UEs combined with msg3-repetition.

FeatureCombination-r17 ::= SEQUENCE {

| | | |
|---|---|---|
| redCap-r17 | ENUMERATED {true} | OPTIONAL, -- Need R |
| smallData-r17 | ENUMERATED {true} | OPTIONAL, -- Need R |
| nsag-r17 | NSAG-List-r17 | OPTIONAL, -- Need R |
| msg3-Repetitions-r17 | ENUMERATED {true} | OPTIONAL, -- Need R |
| spare4 | ENUMERATED {true} | OPTIONAL, -- Need R |
| spare3 | ENUMERATED {true} | OPTIONAL, -- Need R |
| spare2 | ENUMERATED {true} | OPTIONAL, -- Need R |
| spare1 | ENUMERATED {true} | OPTIONAL -- Need R |

}

Then there may be three cases regarding the PRACH resources for SBFD aware UEs. In case 1, the SBFD aware UEs might share same ROs with the legacy non-SBFD aware UEs, but they are configured with a set of separate preambles. In case 2, the SBFD aware UE might be configured with separate ROs, and the ROs are shared with other features such as RedCap/small data/nsag/msg3-repetition. In case 3, the SBFD aware UE might be configured with separate ROs, and the ROs are uniquely configured for SBFD aware UEs.

Especially for cases of configuring separate ROs (i.e., case 2 and case 3), some ROs might be located in the SBFD symbols and within the UL subband. This provides a chance to use such ROs for SBFD aware UEs. However, if these ROs are also shared with other features (i.e., case 2), they might not be used given that this results in misaligned synchronization signal and physical broadcast channel (PBCH) block (SSB) to RO association for different kind of UEs, which is hard for BS to determine receiver beamforming for detecting Msg1 preamble.

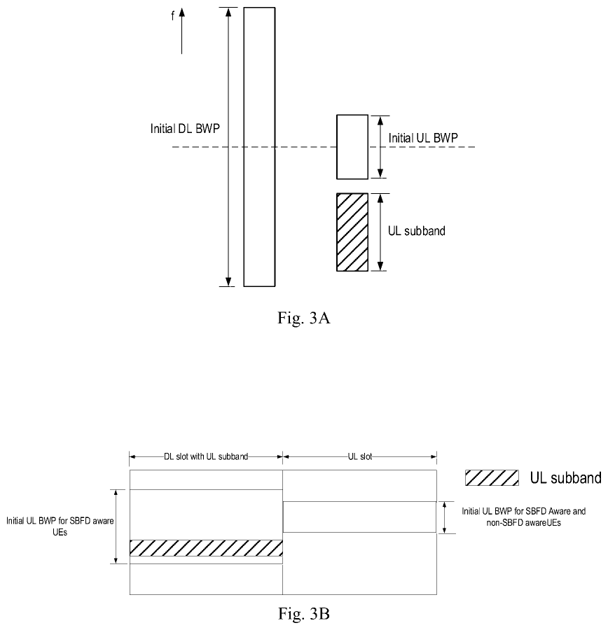

FIG. 5 illustrates an example diagram of ROs shared by SBFD aware UEs and RedCap UEs. Two ROs are located in the SBFD symbols and within the UL subband, i.e., the ROs in dark color, and others are located in the UL symbols. If these two ROs are valid ROs for SBFD aware UEs, the SSB to RO association of SBFD aware UEs will be different with RedCap UEs, as shown in FIG. 5. This is because the RedCap UEs do not know the existence of the UL subband, and they treat these two ROs as invalid. From BS point of view, the BS typically determines receiver beamforming based on the associated SSB. However, now one RO is associated with two different SSBs, which makes hard for BS to determine the beamforming for detecting the Msg1 from different UEs.

It is to be understood that RedCap UEs are provided as an example of SBFD non-aware UEs. FIG. 5 can be applicable for the scenario that ROs are shared by SBFD aware UEs and any other type of SBFD non-aware UEs.

Based on this, it is proposed that for an RO that is located within the UL subband in the SBFD symbols, whether the RO is valid is determined by whether and how the ROs are shared by other features.

In some embodiments, if the RO is configured for SBFD aware devices and not for non-SBFD aware devices, i.e., if the RO is configured uniquely for SBFD aware UEs (e.g., the above case 3), the RO can be determined as valid for SBFD aware UEs. Alternatively, if the RO is configured for a feature combination of SBFD aware UEs and Msg3 repetition, the RO can be determined as valid for SBFD aware UEs. In some embodiments, if the RO is shared by SBFD aware UEs and SBFD non-aware UEs, such as RedCap UEs and/or Msg3-repetition UEs, then the RO can be determined as not valid for SBFD aware UEs.

If the RO is valid, the UE could transmit a preamble in the RO, otherwise the RO cannot be used for Msg1 preamble transmission.

To use the separate initial UL BWP for Msg4 HARQ-ACK/NACK feedback, it could be assumed that the separate configured initial UL BWP for SBFD aware UEs always contain the legacy initial UL BWP, such that the channels (e.g., PUCCH for Msg4 HARQ-ACK/NACK) configured in the legacy initial UL BWP is available for SBFD aware UEs as well. Therefore, the PUCCHs from the SBFD aware UEs and non-SBFD aware UEs can be multiplexed in the same resource, which is beneficial from resource utilization efficiency point of view.

On the other hand, the PUCCH transmitted in the UL subband for Msg4 HARQ-Ack feedback might suffer from Cross-link interference (CLI) (e.g., DL transmission interferes UL receptions in the gNB side). This might lead to worse detection performance for PUCCH in SBFD symbols than in UL symbols. To improve PUCCH performance, separate PUCCH configurations can be configured for PUCCH transmission in the UL subband. The separate PUCCH configurations could configure e.g., separate PUCCH resources and more robust PUCCH format for Msg4 HARQ-ACK/NACK feedback. The separate PUCCH resources and PUCCH format could be configured based on legacy specified PUCCH configuration table or could be based a new table.

For example, the legacy specified PUCCH configuration table is shown in Table 1, wherein PUCCH format 0 or PUCCH format 1 can be indicated for PUCCH transmission. Typically PUCCH format 1 has better performance than PUCCH format 0 because it could use more symbols for PUCCH transmission. A new PUCCH configuration table could be based on the legacy table by removing the items corresponding to PUCCH format 0 (i.e., items with index 0,1,2) and replacing with PUCCH format 1 with number of symbols different than those specified in the legacy table (i.e., 4, 10, 14).

TABLE 1
PUCCH configuration table

| | | | | PRB offset | |
|---|---|---|---|---|---|
| Index | PUCCH format | First symbol | Number of symbols | ${RB}_{BWP}^{offset}$ | Set of initial CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

Regarding the usage of the separate PUCCH resources, there can be three options. In option 1, the separate configured PUCCH resources are applicable only in DL symbols or flexible symbols configured with the UL subband, i.e., in SBFD symbols. In option 2, the separate configured PUCCH resources are applicable for both DL symbols or flexile symbols configured with the UL subband and a UL slot, i.e., for both SBFD symbols and non-SBFD symbols. In option 3, whether the PUCCH resource is applicable for non-SBFD symbols (i.e., in a UL slot) is determined based on configuration information from the network device.

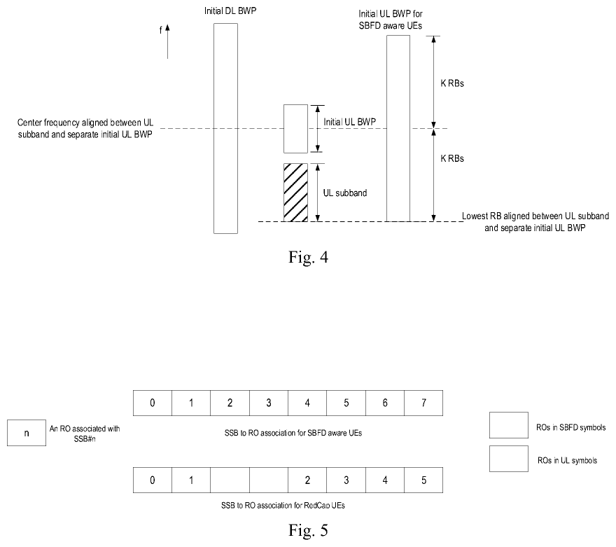

FIG. 6 illustrates a flowchart of a method 600 implemented at a terminal device according to some embodiments of the present disclosure. In some embodiments, the method 600 can be implemented at a communication device, such as the terminal device 110 as shown in FIG. 1A. In some other embodiments, the method 600 may be implemented at devices not shown in FIG. 1A. Further, it is to be understood that the method 600 may include additional blocks not shown and/or may omit some blocks as shown, and the scope of the present disclosure is not limited in this regard. For the purpose of discussion, the method 600 will be described from the perspective of the terminal device 110 with reference to FIG. 1A and FIG. 2.

At block 610, the terminal device 110 receives a configuration related to a first initial UL BWP and a second initial UL BWP (e.g., the separate initial UL BWP) from a network device 120. The configuration might be a SIB signaling, in which different information element is related with the configuration of the first initial UL BWP and the configuration of second initial UL BWP.

At block 620, the terminal device 110 determines the second initial UL BWP based on the configuration. The second initial UL BWP comprises a UL subband.

In some embodiments, the configuration may indicate a frequency location and bandwidth of the second initial UL BWP. In this case, the terminal device 110 may determine the second initial UL BWP based on the indicated frequency location and bandwidth of the second initial UL BWP. Alternatively, the configuration may indicate to determine the second initial UL BWP, and the determination may be based on a frequency location of at least one of the UL subband, the first initial UL BWP and an initial DL BWP.

In some embodiments, the second initial UL BWP may be applicable to DL symbols or flexible symbols configured with the UL subband and may be applicable to a UL slot. Alternatively, the first UL BWP may be applicable to a UL slot, and the second initial UL BWP may be applicable to DL symbols or flexible symbols configured with the UL subband. In some embodiments, the second initial UL BWP may be applicable to DL symbols or flexible symbols configured with the UL subband, and whether the second initial UL BWP is applicable to a UL slot may be based on configuration information from the network device.

In some embodiments, the terminal device 110 may determine an RO within the UL subband in the corresponding DL symbols or flexible symbols as valid or invalid. For example, if the RO is configured for SBFD aware devices and not for non-SBFD aware devices, the terminal device 110 may determine the RO as valid. The SBFD aware devices are aware that the network device 120 receives UL data in DL symbols or flexible symbols configured with the UL subband. Alternatively, if the RO is configured for a combination of a feature of SBFD aware devices and a feature of Msg3 repetition, the terminal device 110 may determine the RO as valid. Alternatively, if the RO is shared by SBFD aware devices and non-SBFD aware devices, the terminal device 110 may determine the RO as invalid.

In some embodiments, the terminal device 110 may transmit an Msg1 of a random access procedure to the network device 120. The Msg1 may comprise an indication that the terminal device is an SBFD aware device. For example, the terminal device 110 may transmit a preamble selected from a set of preambles dedicated to SBFD aware devices.

In some embodiments, the terminal device 110 may determine a PUCCH resource (e.g., the separate PUCCH resource) for transmitting feedback for an Msg4 of a random access procedure. The PUCCH resource may be in the first initial UL BWP or the second initial UL BWP.

In some embodiments, the PUCCH resource may be applicable in DL symbols or flexible symbols configured with the UL subband. Alternatively, the PUCCH resource may be applicable in DL symbols or flexile symbols configured with the UL subband and a UL slot. In some embodiments, whether the PUCCH resource is applicable in a UL slot may be determined based on configuration information from the network device.

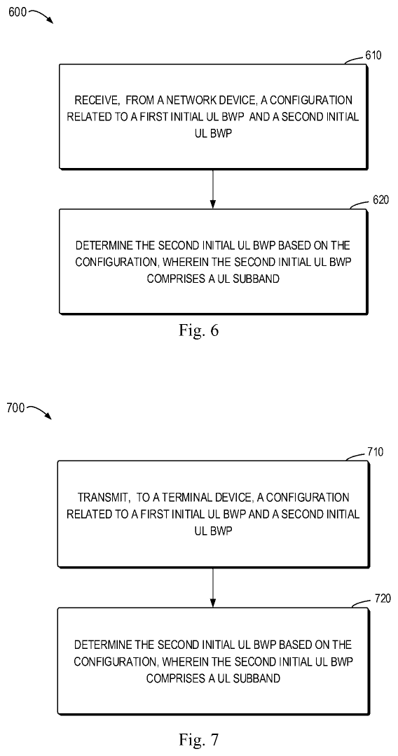

FIG. 7 illustrates a flowchart of a method 700 implemented at a network device according to some embodiments of the present disclosure. In some embodiments, the method 700 can be implemented at a communication device, such as the network device 120 as shown in FIG. 1A. In some other embodiments, the method 700 may be implemented at devices not shown in FIG. 1A. Further, it is to be understood that the method 700 may include additional blocks not shown and/or may omit some blocks as shown, and the scope of the present disclosure is not limited in this regard. For the purpose of discussion, the method 700 will be described from the perspective of the network device 120 with reference to FIG. 1A and FIG. 2.

At block 710, the network device 120 transmits a configuration related to a first initial UL BWP and a second initial UL BWP (e.g., the separate initial UL BWP) to a terminal device 110.

At block 720, the network device 120 determines the second initial UL BWP based on the configuration. The second initial UL BWP may comprise a UL subband.

In some embodiments, the configuration may indicate a frequency location and bandwidth of the second initial UL BWP. In this case, the network device 120 may determine the second initial UL BWP based on the indicated frequency location and bandwidth of the second initial UL BWP. Alternatively, the configuration may indicate to determine the second initial UL BWP, and the determination may be based on a frequency location of at least one of the UL subband, the first initial UL BWP and an initial DL BWP.

In some embodiments, the second initial UL BWP may be applicable to DL symbols or flexible symbols configured with the UL subband and may be applicable to a UL slot. Alternatively, the first UL BWP may be applicable to a UL slot, and the second initial UL BWP may be applicable to DL symbols or flexible symbols configured with the UL subband. In some embodiments, the second initial UL BWP may be applicable to DL symbols or flexible symbols configured with the UL subband, and whether the second initial UL BWP is applicable to a UL slot may be based on configuration information from the network device.

In some embodiments, the network device 120 may configure an RO within the UL subband in the corresponding DL symbols or flexible symbols for SBFD aware devices. The SBFD aware devices are aware that the network device receives UL data in DL symbols or flexible symbols configured with the UL subband. Alternatively or in addition, the network device 120 may configure an RO within the UL subband in the corresponding DL symbols or flexible symbols for a combination of a feature of SBFD aware devices and a feature of Msg3 repetition. Alternatively or in addition, the network device 120 may configure an RO within the UL subband in the corresponding DL symbols or flexible symbols for sharing by SBFD aware devices and non-SBFD aware devices.

In some embodiments, the network device 120 may receive an Msg1 of a random access procedure from the terminal device 110. The Msg1 may comprise an indication that the terminal device is an SBFD aware device. For example, the network device 120 may configure a set of preambles dedicated to SBFD aware devices, and receive a preamble selected by the terminal device from the set of preambles.

In some embodiments, the network device 120 may configure a PUCCH resource (e.g., the separate PUCCH resource) for receiving feedback for an Msg4 of a random access procedure. The PUCCH resource may be in the first initial UL BWP or the second initial UL BWP.

In some embodiments, the PUCCH resource may be applicable in DL symbols or flexible symbols configured with the UL subband. Alternatively, the PUCCH resource may be applicable in DL symbols or flexile symbols configured with the UL subband and a UL slot. In some embodiments, the network device 120 may determine configuration information on whether the PUCCH resource is applicable in a UL slot.

As such, it is provided solutions for an initial access for UEs in a full duplex network, which may use a UL subband for SBFD aware UEs during the initial access. It may not impact the legacy UEs performance, and SBFD aware UEs implementation complexity may be not increased.

### Example Apparatus

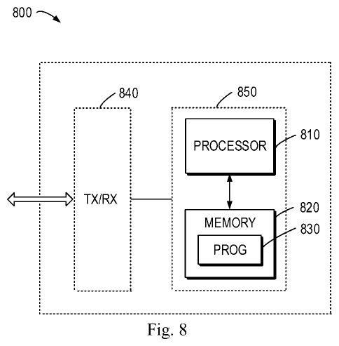

FIG. 8 illustrates a simplified block diagram of a device 800 that is suitable for implementing embodiments of the present disclosure. The device 800 can be considered as a further example implementation of the terminal device 110, and the network device 120 as shown in FIG. 1A. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 830 is assumed to include program instructions that, when executed by the associated processor 810, enable the device 800 to operate in accordance with the embodiments of the present disclosure, as discussed herein with reference to FIGS. 1A-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, an apparatus capable of performing the method 700 (for example, the terminal device 110) may comprise means for performing the respective steps of the method 700. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 700.

In some embodiments, an apparatus capable of performing the method 800 (for example, the network device 120) may comprise means for performing the respective steps of the method 800. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 800.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.
Clause 1. A terminal device comprising: a processor; and a transceiver coupled to the processor, wherein the processor is configured to: receive, via the transceiver from a network device, a configuration related to a first initial uplink (UL) bandwidth part (BWP) and a second initial UL BWP; and determine the second initial UL BWP based on the configuration, wherein the second initial UL BWP comprises a UL subband.
Clause 2. The terminal device of clause 1, wherein the configuration indicates a frequency location and bandwidth of the second initial UL BWP, and the processor is configured to determine the second initial UL BWP based on the indicated frequency location and bandwidth of the second initial UL BWP.
Clause 3. The terminal device of clause 1, wherein the configuration indicates to determine the second initial UL BWP, and wherein the determination is based on a frequency location of at least one of the UL subband, the first initial UL BWP and an initial downlink (DL) BWP.
Clause 4. The terminal device of clause 1, wherein the second initial UL BWP is applicable to DL symbols or flexible symbols configured with the UL subband and is applicable to a UL slot.
Clause 5. The terminal device of clause 1, wherein the first UL BWP is applicable to a UL slot, and the second initial UL BWP is applicable to DL symbols or flexible symbols configured with the UL subband.
Clause 6. The terminal device of clause 1, wherein the second initial UL BWP is applicable to DL symbols or flexible symbols configured with the UL subband, and whether the second initial UL BWP is applicable to a UL slot is based on configuration information from the network device.
Clause 7. The terminal device of any of clauses 1-6, wherein the processor is further configured to: determine a random access channel (RACH) occasion (RO) within the UL subband in the corresponding DL symbols or flexible symbols as valid or invalid.
Clause 8. The terminal device of clause 7, wherein the processor is configured to determine the RO as valid or invalid by: in the case that the RO is configured for sub-band full duplex (SBFD) aware devices and not for non-SBFD aware devices, determining the RO as valid, wherein the SBFD aware devices are aware that the network device receives UL data in DL symbols or flexible symbols configured with the UL subband.
Clause 9. The terminal device of clause 7, wherein the processor is configured to determine the RO as valid or invalid by: in the case that the RO is configured for a combination of a feature of SBFD aware devices and a feature of Message 3 (Msg3) repetition, determining the RO as valid.
Clause 10. The terminal device of clause 7, wherein the processor is configured to determine the RO as valid or invalid by: in the case that the RO is shared by SBFD aware devices and non-SBFD aware devices, determining the RO as invalid.
Clause 11. The terminal device of clause 1, wherein the processor is further configured to: transmit, via the transceiver to the network device, a Message 1 (Msg1) of a random access procedure, wherein the Msg1 comprises an indication that the terminal device is an SBFD aware device.
Clause 12. The terminal device of clause 11, wherein the processor is configured to transmit the Msg1 by: transmitting a preamble selected from a set of preambles dedicated to SBFD aware devices.
Clause 13. The terminal device of any of clauses 1-6, wherein the processor is further configured to: determine a physical uplink control channel (PUCCH) resource for transmitting feedback for a Message 4 (Msg4) of a random access procedure, wherein the PUCCH resource is in the first initial UL BWP or the second initial UL BWP.
Clause 14. The terminal device of clause 13, wherein the PUCCH resource is applicable in one of the following: DL symbols or flexible symbols configured with the UL subband; or DL symbols or flexile symbols configured with the UL subband and a UL slot.
Clause 15. The terminal device of clause 13, wherein whether the PUCCH resource is applicable in a UL slot is determined based on configuration information from the network device.
Clause 16. A network device comprising: a processor; and a transceiver coupled to the processor, wherein the processor is configured to: transmit, via the transceiver to a terminal device, a configuration related to a first initial uplink (UL) bandwidth part (BWP) and a second initial UL BWP; and determine the second initial UL BWP based on the configuration, wherein the second initial UL BWP comprises a UL subband.
Clause 17. The network device of clause 16, wherein the configuration indicates a frequency location and bandwidth of the second initial UL BWP, and the processor is configured to determine the second initial UL BWP based on the indicated frequency location and bandwidth of the second initial UL BWP.
Clause 18. The network device of clause 16, wherein the configuration indicates to determine the second initial UL BWP, and the determination is based on a frequency location of at least one of the UL subband, the first initial UL BWP and an initial downlink (DL) BWP.
Clause 19. The network device of clause 16, wherein the second initial UL BWP is applicable to DL symbols or flexible symbols configured with the UL subband and is applicable to a UL slot.
Clause 20. The network device of clause 16, wherein the first UL BWP is applicable to a UL slot, and the second initial UL BWP is applicable to DL symbols or flexible symbols configured with the UL subband.
Clause 21. The network device of clause 16, wherein the second initial UL BWP is applicable to DL symbols or flexible symbols configured with the UL subband, and whether the second initial UL BWP is applicable to a UL slot is based on configuration information from the network device.
Clause 22. The network device of any of clauses 16-20, wherein the processor is further configured to: configure a random access channel (RACH) occasion (RO) within the UL subband in the corresponding DL symbols or flexible symbols for one of the following: sub-band full duplex (SBFD) aware devices, wherein the SBFD aware devices are aware that the network device receives UL data in DL symbols or flexible symbols configured with the UL subband, a combination of a feature of SBFD aware devices and a feature of Message 3 (Msg3) repetition, or sharing by SBFD aware devices and non-SBFD aware devices.
Clause 23. The network device of clause 16, wherein the processor is further configured to: receive, via the transceiver from the terminal device, a Message 1 (Msg1) of a random access procedure, wherein the Msg1 comprises an indication that the terminal device is an SBFD aware device.
Clause 24. The network device of clause 23, wherein the processor is configured to receive the Msg1 by: configuring a set of preambles dedicated to SBFD aware devices; and receiving a preamble selected from the set of preambles.
Clause 25. The network device of any of clauses 16-20, wherein the processor is further configured to: configure a physical uplink control channel (PUCCH) resource for receiving feedback for a Message 4 (Msg4) of a random access procedure, wherein the PUCCH resource is in the first initial UL BWP or the second initial UL BWP.
Clause 26. The network device of clause 25, wherein the PUCCH resource is applicable in one of the following: DL symbols or flexible symbols configured with the UL subband; or DL symbols or flexile symbols configured with the UL subband and a UL slot.
Clause 27. The network device of clause 25, wherein the processor is further configured to: determine configuration information on whether the PUCCH resource is applicable in a UL slot.
Clause 28. A method performed by a terminal device, comprising: receiving, from a network device, a configuration related to a first initial uplink (UL) bandwidth part (BWP) and a second initial UL BWP; and determining the second initial UL BWP based on the configuration, wherein the second initial UL BWP comprises a UL subband.
Clause 29. A method performed by a network device, comprising: transmitting, to a terminal device, a configuration related to a first initial uplink (UL) bandwidth part (BWP) and a second initial UL BWP; and determining the second initial UL BWP based on the configuration, wherein the second initial UL BWP comprises a UL subband.
Clause 30. A non-transitory computer readable medium having instructions stored thereon, the instructions, when executed by a processor of an apparatus, causing the apparatus to perform at least the method of clause 28 or 29.

1. A terminal device comprising:
at least one memory; and
at least one processor coupled with the at least one memory and configured to cause the terminal device to:
receive a configuration related to a first initial uplink (UL) bandwidth part (BWP) and a second initial UL BWP; and
determine the second initial UL BWP based on the configuration, wherein the second initial UL BWP comprises a UL subband.

2. The terminal device of claim 1, wherein the configuration indicates a frequency location and bandwidth of the second initial UL BWP, and the processor is configured to determine the second initial UL BWP based on the frequency location and bandwidth of the second initial UL BWP.

3. The terminal device of claim 1, wherein the configuration indicates to determine the second initial UL BWP, and wherein the determination is based on a frequency location of at least one of the UL subband, the first initial UL BWP and an initial downlink (DL) BWP.

4. The terminal device of claim 1, wherein the second initial UL BWP is applicable to DL symbols or flexible symbols configured with the UL subband and is applicable to a UL slot.

5. The terminal device of claim 1, wherein the first UL BWP is applicable to a UL slot, and the second initial UL BWP is applicable to DL symbols or flexible symbols configured with the UL subband.

6. The terminal device of claim 1, wherein the second initial UL BWP is applicable to DL symbols or flexible symbols configured with the UL subband, and whether the second initial UL BWP is applicable to a UL slot is based on configuration information from a network device.

7. The terminal device of claim 1, wherein the at least one processor is configured to cause the terminal device to:
determine a random access channel (RACH) occasion (RO) within the UL subband in the corresponding DL symbols or flexible symbols as valid or invalid.

8. The terminal device of claim 7, wherein the at least one processor is configured to cause the terminal device to determine the RO as valid or invalid by:
in response to the RO being configured for sub-band full duplex (SBFD) aware devices and not for non-SBFD aware devices, determining that the RO is valid, wherein the SBFD aware devices are aware that a network device receives UL data in DL symbols or flexible symbols configured with the UL subband.

9. The terminal device of claim 7, wherein the at least one processor is configured to cause the terminal device to determine the RO as valid or invalid by:
in response to the RO being configured for a combination of a feature of SBFD aware devices and a feature of Message 3 (Msg3) repetition, determining that the RO is valid.

10. The terminal device of claim 7, wherein the at least one processor is configured to cause the terminal device to determine the RO as valid or invalid by:
in response to the RO being shared by SBFD aware devices and non-SBFD aware devices, determining that the RO is invalid.

11. The terminal device of claim 1, wherein the at least one processor is configured to cause the terminal device to:
transmit a Message 1 (Msg1) of a random access procedure, wherein the Msg1 comprises an indication that the terminal device is an SBFD aware device.

12. The terminal device of claim 11, wherein the at least one processor is configured to cause the terminal device to transmit the Msg1 by:
transmitting a preamble selected from a set of preambles dedicated to SBFD aware devices.

13. The terminal device of claim 1, wherein the at least one processor is configured to cause the terminal device to:
determine a physical uplink control channel (PUCCH) resource for transmitting feedback for a Message 4 (Msg4) of a random access procedure, wherein the PUCCH resource is in the first initial UL BWP or the second initial UL BWP.

14. A network device comprising:
at least one memory; and
at least one processor coupled with the at least one memory and configured to cause the network device to:
transmit a configuration related to a first initial uplink (UL) bandwidth part (BWP) and a second initial UL BWP; and
determine the second initial UL BWP based on the configuration, wherein the second initial UL BWP comprises a UL subband.

15. A method performed by a terminal device, comprising:
receiving a configuration related to a first initial uplink (UL) bandwidth part (BWP) and a second initial UL BWP; and
determining the second initial UL BWP based on the configuration, wherein the second initial UL BWP comprises a UL subband.

16. A processor for wireless communication, comprising:
at least one controller coupled with at least one memory and configured to cause the processor to:
receive a configuration related to a first initial uplink (UL) bandwidth part (BWP) and a second initial UL BWP; and
determine the second initial UL BWP based on the configuration, wherein the second initial UL BWP comprises a UL subband.

17. The processor of claim 16, wherein the configuration indicates a frequency location and bandwidth of the second initial UL BWP, and the processor is configured to determine the second initial UL BWP based on the frequency location and bandwidth of the second initial UL BWP.

18. The processor of claim 16, wherein the configuration indicates to determine the second initial UL BWP, and wherein the determination is based on a frequency location of at least one of the UL subband, the first initial UL BWP and an initial downlink (DL) BWP.

19. The processor of claim 16, wherein the second initial UL BWP is applicable to DL symbols or flexible symbols configured with the UL subband and is applicable to a UL slot.

20. The processor of claim 16, wherein the first UL BWP is applicable to a UL slot, and the second initial UL BWP is applicable to DL symbols or flexible symbols configured with the UL subband.
